(19) United States
(12) Patent Application Publication
(10) Pub. No.: US 2014/0279577 A1
(43) Pub. Date: Sep. 18, 2014

(54) WASTE MANAGEMENT SYSTEM

(71) Applicant: WISErg Corporation, Redmond, WA (US)

(72) Inventors: Ken Deering, Medina, WA (US); Scot Fordyce, Bellevue, WA (US); Larry LeSueur, Sammamish, WA (US); Jose Lugo, Kirkland, WA (US); Victor V. Tryon, Woodinville, WA (US); Michael Bridges, Seattle, WA (US); Lee Wilkerson, Stanwood, WA (US); Trevor Lewis, Bellevue, WA (US)

(73) Assignee: WISErg Corporation, Redmond, WA (US)

(21) Appl. No.: 14/205,176

(22) Filed: Mar. 11, 2014

Related U.S. Application Data
(60) Provisional application No. 61/778,127, filed on Mar. 12, 2013.
(60) Provisional application No. 61/809,225, filed on Apr. 5, 2013.

(51) Int. Cl. G06Q 10/00

(52) U.S. Cl. CPC G06Q 10/30
USPC 705/308

(57) ABSTRACT

Aspects of the present disclosure relate to the management of waste and information related to waste processing. A waste processing unit is configured to receive and at least partially process waste, such as organic based food waste. As part of the collection process, the waste processing unit can include a user interface and input devices that receive or generate waste processing information associated with the deposit of the waste in the waste processing unit. The waste processing information can be processed locally by the waste processing unit. Additionally, the collected or processed waste processing information can be transmitted to a waste processing unit information service for further data collection and analysis.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. §1.57.

### BACKGROUND

Organic fertilizers are useful for assisting in the growth of agricultural crops, residential plants, and landscaping flora without the need for synthetic or petroleum-based fertilizers. It is known in the art that organic fertilizers have enhanced benefits over traditional fertilizers that extend beyond the plant to positively affect the health of soils. Compared to traditional fertilizers, organic fertilizers have been shown to decrease negative environmental impacts associated with nutrient leaching into the environment, and increase useful biotic activity in soils.

The organic fraction of municipal solid waste (OFMSW), and more specifically, the food waste subcomponent therein, is a nuisance and environmental waste issue. Rainwater percolates through landfills, where food waste is deposited, and leads to heavy metals and minerals leaching, thus contributing to the contamination of soils, surface water and ground water. Decaying waste emits greenhouse gasses which subsequently cause significant environmental concern. Food waste also causes odor, vector and rodent issues both in landfills and composting facilities, the latter of which have been specifically designed to recover food waste nutrition. In the United States alone, some 34 million tons of food waste are produced each year and nearly 33 million tons is committed to landfills for disposal, the cost of which is usually borne by the waste producer in the form of tipping fees.

Despite being considered waste that is unsuitable for human or animal consumption, a high level of valuable nutrition remains in the food waste that can be processed into various agricultural or other products. Agricultural products derived from organic waste, including food waste, have been shown to: (a) exhibit plant growth acceleration that equals or outperforms traditional, synthetic or petroleum based fertilizers; (b) increase the long-term health of carbon-depleted soils; and (c) command monetary premiums in distribution markets. It is therefore a useful economic and environment-sustaining endeavor to develop a process to produce fertilizers from food waste for the dual benefits of providing for nutrient-rich organic fertilizers for agricultural purposes, and to reduce the nuisance and cost issues related to traditional food waste disposal.

Additional economic and environmental benefits can be achieved by producing fertilizers that are approved for use in organic crop production by an accredited certifying agent. The use of food waste as a feedstock may produce fertilizers that are approved for use, whereas many traditional fertilizers derived from traditional synthetic and petroleum-based sources generally cannot be approved.

Anaerobic digestion is a biological process in which microorganisms break down a material in the absence (or limited presence) of oxygen. Although this may take place naturally within a landfill over extended periods of time, the term anaerobic digestion typically describes a contained and accelerated operation. Anaerobic digestion can be used for processing various waste materials, such as sewage or food waste.

Anaerobic digestion can yield components including biogas, digestate (or solid effluent), and liquid effluent. Biogas is generated by the microorganisms digesting the organic material and may be comprised of, including but not limited to; methane, carbon dioxide, water, and other gases. This biogas, and in particular methane, can be used as an alternative energy source. The digestate (solid effluent) may be further processed and used as compost. The liquid effluent may be disposed (for example, via municipal wastewater treatment), or may be utilized as a nutrient-rich organic fertilizer, or may be further nutritionally augmented with organic material and be utilized as a nutrient-rich fertilizer, or may be further nutritionally augmented with synthetic material and be utilized as a nutrient-rich fertilizer, or may be nutritionally augmented with both organic and synthetic material and utilized as a fertilizer.

### BRIEF DESCRIPTION OF THE DRAWINGS

FIG. 1 is a block diagram illustrative of a waste management environment;

FIG. 2 is a block diagram illustrative of various components of a waste processing unit;

FIG. 3 is a flow diagram illustrative of a waste management routine implemented by a waste processing unit; and

FIGS. 4A-4D are illustrative of interfaces generated by a waste processing unit.

### DETAILED DESCRIPTION

Generally described, aspects of the present disclosure relate to the management of waste and information related to waste processing. In an illustrative embodiment, a waste processing unit is configured to receive and at least partially process waste, such as organic-based food waste. As part of the collection process, the waste processing unit can include a user interface and input devices that receive or generate waste processing information associated with the deposit of the waste in the waste processing unit. Examples of waste processing information can include, but is not limited to, user identification information, waste categorization information, environmental information, multi-media information (such as images or weight), and the like. The waste processing information can be processed locally by the waste processing unit. Additionally, the collected or processed waste processing information can be transmitted to a waste processing unit information service for further data collection and analysis.

Although aspects of the present disclosure will be described with regard to illustrative waste processing units and component interactions, communication protocols, flow diagrams and user interfaces, one skilled in the relevant art will appreciate that the disclosed embodiments are illustrative in nature and should not be construed as limiting. Specifically, although the present disclosure references a waste processing unit, one skilled in the relevant art will appreciate that a waste processing unit may also be referred to as a wireless computing device, a mobile communication device, or a computing device. Still further, although the present disclosure is described with regard to specific displays and specific methodologies and frameworks for generating communication categories and identifying communication activities, the present disclosure should not be construed to require combination of the disclosed embodiments or any specific variation unless such combination or variation is expressly identified.

With reference now to FIG. 1, a block diagram illustrative of a waste management environment 100 will be described. The waste management environment 100 can include one or more waste processing units 102 associated with premises 104. Generally, premises 104 can correspond to one or more physical locations having access to a waste processing unit 102. For example, a premises 104 may include a grocery store, home, apartment building, etc. in which a waste processing unit 102 is located or accessed within a defined physical proximity. One skilled in the relevant art will appreciate that the present disclosure is not limited to any particular type of premises 104 or any specific organizational criteria for determining whether a particular structure, portion of land or the like may be defined as being part of the same premises 104. As illustrated in FIG. 1, a single waste processing unit 102 can correspond or be associated to one or more premises 104. For example, two or more physically distinct or remote premises 104 may share the services provided by a single waste processing unit 102. Additionally, one or more pairs of waste processing units 102 and premises 104 may be logically organized based on association criteria, such as a grocery chain, apartment complex, organization, and the like. As illustrated in FIG. 1 as logical organization 105, the grouped waste processing units 102 and premises 104 may be configured to share waste processing information or the results of the processing of waste processing information.

The waste processing unit 102 can generate various displays that facilitate interaction of a user with other users or other network-based resources. The waste processing unit 102 can correspond to a wide variety of devices or components that are capable of initiating, receiving or facilitating communications over a communication network 106 including, but not limited to, personal computing devices, hand held computing devices, integrated components for inclusion in computing devices, network appliances, vehicles, machinery, smart phones, modems, personal digital assistants, laptop computers, gaming devices, media devices, and the like. Illustrative components of a waste processing unit 102 will be described in greater detail with regard to FIG. 2.

In an illustrative embodiment, the waste processing units include a wide variety of software and hardware components for establishing communications over one or more communication networks, including wireless communication network, a wired communication network (not shown), or an IP-based telecommunication network (not shown).

The waste management environment 100 can include a waste processing unit information service 108. In an illustrative embodiment, the waste processing unit information service 108 may be utilized to provide, maintain or transmit waste processing information transmitted by one or more waste processing units 102. Examples of the processing of waste processing information include the archival of waste processing information, incorporation of waste processing information with other external information (such as inventory management systems), predictive modeling of waste processing activities, and the like.

While the waste processing unit information service 108 is depicted in FIG. 1 as implemented as a single component in the waste management environment 100, this is illustrative only. The waste processing unit information service 108 may be embodied in a plurality of computing devices, each executing software or executable code that causes the computing device to implement one or more aspects of the waste processing unit information service 108. A server or other computing device implementing the waste processing unit information service may include memory, processing unit(s), and computer readable medium drive(s), all of which may communicate with one another by way of a communication bus. A network interface may provide connectivity over the network or other networks or computer systems. The processing unit(s) may communicate to and from memory containing program instructions that the processing unit(s) executes in order to operate the waste processing unit information service. The memory generally includes RAM, ROM and/or other persistent and auxiliary memory.

The waste processing unit information service 108 can include an external data source interface component for obtaining external information from network data sources, such as location data, contact data, inventory data, and other data. For example, an external data source interface component can obtain inventory data from a premises 104 associated with a waste processing unit 102. The waste processing unit information service 108 can also include a device interface component for obtaining information from one or more waste processing units 102. One skilled in the relevant art will also appreciate that the waste processing unit information service 108 may include any one of a number of additional hardware and software components that would be utilized in the illustrative computerized network environment to carry out the illustrative functions of the waste processing unit information service 108 or any of the individually identified components. For example, the waste processing unit information service 108 may be associated with one or more data processing components, and devices thereof, for processing waste processing information provided by the waste processing units 102 or external sources.

With reference now to FIG. 2, illustrative components of a waste processing unit 102 for use in the collection of waste and generation and processing of waste processing information will be described. The waste processing unit 102 may include one or more processing units 202, such as one or more CPUs. The waste processing unit 102 may also include system memory 204, which may correspond to any combination of volatile and/or non-volatile storage mechanisms. The system memory 204 may store information which provides an operating system component 206, various program components 208, program data 210, a communication management module 212 or other components. The above-enumerated list of components is representative and is not exhaustive of the types of functions performed, or components implemented, by the waste processing unit 102. One skilled in the relevant art will appreciate that additional or alternative components may also be included in the waste processing unit 102 to carry out other intended functions such as a mobile telephone functions, data processing functions, and the like.

Illustratively, the waste processing unit 102 performs functions by using the processing unit(s) 202 to execute instructions provided by the system memory 204. The waste processing unit 102 may also include one or more input devices 214 for obtaining information associated with the collection or generation of waste processing information. Illustrative input devices 214 include, but are not limited to keyboard, mouse device, specialized selection keys, multi-media capture devices and the like. Additionally, the input devices 214 can also include one or more biological components for performing biological analysis or processes on waste products, as will be described below. The waste processing unit 102 can also include one or more output devices 216 for generating outputs to one or more users, including, but not limited to displays, printers, audio output mechanisms, and the like. Illustrative user interfaces for a waste processing unit will be described with regard to FIGS. 4A-4D.

With continued reference to FIG. 2, the waste processing unit 102 may also include one or more types of removable storage 218 and one or more types of non-removable storage 220. Still further, the waste processing unit 102 can include communication components 222 for facilitating communication via wired and wireless communication networks 106, such as the wireless communication networks and wired networks. Examples of various communication protocols include, but are not limited to, Bluetooth, the family of IEEE 802.11 technical standards (“WiFi”), the IEEE 802.16 standards (“WiMax), short message service (“SMS”), voice over IP (“VoIP”), as well as various generation cellular air interface protocols (including, but not limited to, air interface protocols based on CDMA, TDMA, GSM, WCDMA, CDMA2000, TD-SCDMA, WTDMA, LTE, OFDMA and similar technologies).

As previously described, in accordance with an aspect of the present disclosure, a waste processing unit 102 can generate one or more displays on a user interface via an output device 216. In an illustrative embodiment, the displays include various display objects that represent waste processing categories that may be selectable by a user via any one of a variety of input methods and devices. Additionally, the waste processing unit 102 can also capture multi-media information related to the collection of waste products to assist in the generation of waste processing information or assist in the waste processing process. Examples of multi-media information can include video or still images, weight, texture, aural, sound, etc. Still further, the waste processing unit 102 can further capture information associated with the waste products to be used for determining waste processing categories including weight and associated properties. For example, the waste products may be tested to determine properties related to the ability to absorb various types of electromagnetic waves. In another example, the waste products may be tested to determine the presence and quantities of biological or chemical indicators for assistance in characterizing the waste product. The waste product unit 102 may be further associated with a data store 224 for maintaining collected or generated waste product information as part of the ongoing operation of the waste processing unit. Although illustrated as a single data store, the data store 224 may correspond to any number of components, local or remote, for maintaining waste processing information.

The waste processing unit 102 can further include a waste processing subsystem 226 that at least partially initiates various biological processes related to the processing of the waste processes. An example of such a waste processing system is described in commonly owned U.S. patent application Ser. No. 13/749,528, entitled METHODS AND SYSTEMS FOR PROCESSING ORGANIC MATERIAL, and filed on Jan. 24, 2013. U.S. patent application Ser. No. 13/749,528 is incorporated in its entirety by reference herein. Another example of an illustrative waste processing system is described in commonly owned U.S. Provisional Patent Application No. 61/809,225, entitled METHODS and SYSTEMS FOR STABILIZING ORGANIC MATERIAL, and filed on Apr. 5, 2013, and which was previously incorporated by reference.

Turning now to FIG. 3, an illustrative routine 300 implemented by a waste processing unit 102 for the collection of waste product on a premises 104 will be described. Aspects of the routine will be described with regard to FIGS. 4A-4D.

As previously described, an illustrative waste processing unit 102 can include various input devices 214 and output devices 216 for generating information prompting a user for information, obtaining user inputted information and initiating the processing of collected waste product. FIG. 4A is a block diagram illustrative of an interface 400 associated with a waste processing unit 102 for collecting various information prior to or during the processing of waste products. As will be described in greater detailed below, interface 400 can include inputs 402, 404, 406, and 408 for collecting information from a user. Additionally, the interface 400 can include one or more output devices 216, such as a display screen 410. One skilled in the art will appreciate, however, that additional or alternative displays or interface may be implemented in accordance with the present disclosure.

Returning to FIG. 3, at block 302, the waste processing unit 102 obtains user identification and environment information related to the collection of waste product. Illustratively, the collection of user identification information can include the input of information by a user, directly or indirectly. For example, a user may input an access code that is associated with a single user or groups of users. In other embodiments, user identification information may be obtained by the waste processing unit 102 by reading information, such as utilizing bar code scanners, biometric sensors, wireless transmission devices and the like. For example, a user may be associated with a badge that can be ready by the waste processing unit 102 to obtain user identification information by scanning a magnetic card or obtaining the information wirelessly, such as a Near Field Communication (NFC)-based wireless transmission.

With continued reference to block 302, the waste processing unit 102 can also collect various environmental information that may be related to either the collection of the waste products or the user depositing the waste products. The environmental information can include video or still photograph information to verify the user that deposited the waste product. The environmental information can also include temperature, time, geographical position information and the like. Still further, the environmental information can further include information identifying a particular premises 104 that has been associated with the waste processing unit 102.

FIG. 4B is a block diagram of the illustrative interface 400 of FIG. 4A illustrating an embodiment for collecting user identification information. In one embodiment, the user information may be in the form of a user identifier entered by a user or otherwise transmitted by the user. Accordingly, the interface 400 can prompt a user, via the display 410 to enter an access code, such as via keypad input 402.

Upon receipt of the user identification and environmental information, at block 304, the waste processing unit 102 then obtains a selection of waste category information. Illustratively, each waste processing unit 102 can obtain a user selection of various waste categories that best embody the waste product to be deposited at the waste processing unit 102. Illustratively, the waste categories are determined by either the waste processing information service 108 or an administrator associated with a particular premises. In one aspect, the waste category information can be utilized in the generation of waste processing information to determine how much of the particular waste category is collected and the timing associated with the collection of the particular waste category. In another aspect, the waste category information can also be utilized in determining when to initiate the biological processes used to process the collected waster or to determine which type or configurable aspects of biological processes used to process the waste.

In one embodiment, the waste category information can be statically provisioned on each waste processing unit 102. The static provision can be selected in a manner unique to each waste processing unit 102 or premises 104 or common across at least a subset of a group of waste processing units, such as in a logical grouping 106. In another embodiment, the waste category information can also be dynamically provisioned such that the category information may be selectively displayed based on a particular user, premises, time of day, or based on an initial set of user responses. For example, the waste processing unit 102 can generate a number of additional hierarchical based displays that collect more detailed waste category information based an initial set of category selections by the user.

FIG. 4C is a block diagram of the illustrative interface 400 of FIG. 4A illustrating an embodiment for obtaining waste category information from a user. In one embodiment, the interface 400 can include a display of a number of potential waste product categories on the display 410 that are selectable by manipulation of various configured buttons 404. As illustrated in FIG. 4C, the selectable waste product categories include “Meat and Seafood,” “Deli,” “Produce,” “Grocery,” “Juice and Coffee” and “Other.” Illustratively, a user can select one or more waste product categories by manipulation of a corresponding input 404, such as a hard button. Additionally, although the illustrative interface relates to a selection of physical or software buttons, the waste category information may be obtained by other selection mechanisms, such as user touch screen, audio information (e.g., speech recognition), hand gestures, signs or the like.

In another embodiment, the determination of product category information can correspond to a determination of attributes or characteristics of potential waste products by the waste processing unit 102. In this embodiment, the waste processing unit 102 can conduct one or more processing steps on waste products, or representative samples, to determine the characteristics of the waste product. In some embodiments, the waste processing unit 102 can conduct the processing steps without requiring any action or intervention by the users. For example, the waste processing unit 102 can include components for transmitting electromagnetic radiation to a sample of the waste product to determine characteristics or attributes of the waste product sample, such as color, light absorbance, and the like. In another example, the waste processing unit 102 can conduct chemical or biological processes to test for the presence of specific chemical or biological properties of the waste product sample. For example, the waste processing unit 102 can conduct a test to identify whether a waste product sample has any indications of having a specific protein. In these embodiments, the results of the determination of the waste product characteristics can be used to associate a waste product category or to verify a user selection of a waste product category.

After collection of the waste category information, at decision block 306, the waste processing unit 102 determines whether the collection of waste is approved. Illustratively, the waste processing unit 102 can include processing rules that can be utilized to evaluate whether waste collection should be enabled. The processing rules can be based on authority associated with the identified user (either directly or indirectly), types of waste categories, time of day, associated premises, and the like. Additionally, the processing rules can determine whether adequate information has been collected about the user or the waste to be collected. If the waste processing unit 102 determines that the waste product should not be collected, the routine 300 terminates at block 308. Additionally, the waste processing unit 102 can initiate error processing routine(s) that documents data entry errors, unauthorized access, and the like. In other embodiments, the waste processing unit 102 can transmit requests for authorization to the waste processing unit information service 108 to validate at least a portion of the collected information, to obtain additional information, or request additional or supplemental authorization. For example, the waste processing unit information service 108 can determine whether an identified user has been previously associated with fraudulent waste product collection or whether a collection of waste processing information for multiple waste processing units 102 may be indicative of an error condition, fraudulent transaction or escalation event.

Alternatively, if at decision block 306, the waste processing unit 102 determines that waste collection is authorized, the waste processing unit 102 enables waste collection at block 310. Illustratively, the waste processing unit 102 can maintain a waste collection component that is selectably enabled to receive waste (e.g., a door that may be locked or unlocked by the waste processing unit). FIG. 4D is a block diagram of the illustrative interface 400 of FIG. 4A illustrating an embodiment for informing a user that waste collection is authorized and prompting a user to enable the collection process (e.g., proceed with the collection) or prompting the user to deposit waste materials. In this illustration, the display 410 of the interface can inform the user that waste collection has been enabled. Additionally, the interface 400 can further prompt the user to manipulate another input, such as input 406 to cause the de-activation of a locking mechanism.

Once the waste has been collected, at block 312, the waste processing unit 102 then obtains waste identification information. In one embodiment, the waste processing unit 102 can utilize various multi-media or other input devices to collect information about the waste product deposited in the waste processing unit. For example, the waste processing unit 102 can include video or still camera equipment that can capture information about the collected waste. In another example, the waste processing unit 102 can include additional sensors, such as light sensors, color sensors, aural sensors, temperature sensors, etc. that collect information about characteristics of the deposited waste. Still further, the waste processing unit 102 can obtain a weight of the collected waste. In one example, the waste processing unit 102 can process the weight of a collection tray prior to collecting waste materials and the cumulative weight of the collection tray and the collected weight. In another example, the waste processing unit 102 can have a weight sensor (or be in communication with a weight sensor) that provides a weight for the waste processing unit (in whole) prior to the collection of the waste material and a weight from the waste processing unit (in whole) after the collection of the waste material. In these embodiments, the waste processing unit 102 conducts additional processing to determine a weight.

Upon collection of the waste and any waste identification information, the waste processing unit 102 can then initiate one or more biological processing routines for processing the collected waste. In one aspect, the biological processing routines can determine the appropriate biological processes and the timing of the initiation of selected biological processes. Additionally, the biological processing routines can further include the collection of information related to the organic processes being initiated within the waste processing unit. Illustrative biological processes for utilization with a waste processing unit 102 have been previously identified, although not limiting.

At block 316, the waste processing unit 102 can then process any of the collected waste or biological processing information. For example, the waste processing unit 102 can utilize additional software algorithms that process the collected data, such as image recognition, statistical processing, etc. Additionally, the waste processing unit 102 can store information in a local data store. Still further, the waste processing unit 102 can initiate the transmission of information to an external source, such as the waste processing unit information service 108. Even further, the waste processing unit 102 can also generate confirmation information related to the collection of the waste, the collection/generation of waste processing information or the biological processing of the collected waste. One skilled in the relevant art will appreciate that one or more of the processing routines may be executed prior to the initiation of the biological processes or contemporaneously with the initiation of the biological processes. At block 318, the routine 300 terminates.

Illustratively, the waste processing unit information service 108 or waste processing unit 102 can utilize waste processing information in a variety of ways. In one aspect, waste product processing information from a waste processing unit 102 can be compared to external information provided by, or associated with a premises 104. The external information can include, but is not limited to, inventory ordering information, employee attendance information, point-of-sale transaction information, and the like. For example, the waste product processing information associated with a waste processing unit 102 can be processed to determine a spoilage rate for categories of waste products. In turn, inventory management system data can be reviewed and adjusted based on the determined spoilage rate. In another example, waste product processing information can be compared on a user-by-user basis to determine differences in waste processing by particular users, including error rates, waste product rates, and the like. In still a further example, waste product processing information can be combined with financial planning information to associate a financial cost for waste products. In this example, the financial cost may correspond to an amount of lost product, a cost of processing the waste product, a benefit from recycled or repurposed waste product, a cost of operating the waste processing unit 102 and the like.

In another aspect, waste product processing information from a waste processing unit 102 can be processed to identify trends for a single waste processing unit or a selection of waste processing unit. With reference to the previous example, spoilage rates or trends can be determined for one or more waste processing units 102 (irrespective of combination with other sources of data). In another example, waste product processing rates may be utilized to identify trends related to the collection of spoilage. In this example, variations in spoilage rate may be indicative of variations in weather or political conditions that may cause variations in the time for waste product to spoil (increasing or decreasing) or affect customer or employee attendance at the premises. For example, a chain of grocery stores may detect an increase of spoilage rates for waste processing units 102 associated within a geographic region that is experiencing a rise in temperature or that is experiencing a sudden loss in power. In another example, a chain of grocery stores may detect a decrease in spoilage rates for waste processing units 102 in another geographic region in which customers are buying additional provisions due to potential upcoming weather issues or political unrest.

In yet another aspect, the waste processing unit information service 108 or waste processing units 102 can utilize the waste product processing information in support of certification of premises or vendors. In this aspect, the waste processing unit information service 108 can utilize independently collected waste product processing information to determine an amount or percentage of waste product processing information for a premises or set of premises. The waste processing unit information service 108 can then apply business logic rules to determine whether the premises or set of premises would qualify for particular certifications.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A method for managing waste product information comprising:
obtaining, at a waste processing unit, user identification and environment information associated with a target waste product collection;
determining, by the waste processing unit, one or more waste product categories associated with the target waste product collection;
determining, by the waste processing unit, whether to enable waste product collection based on an evaluation of the user identification, environment information and waste product categories;
if waste product collected is determined to be enabled, causing, by the waste processing unit, collection of waste product;
obtaining, by the waste processing unit, waste identification information associated with the collected waste product;
causing, by the waste processing unit, biological processing of the collected waste product; and
processing information associated with the biological processing of waste product processing information, wherein the waste product processing information includes at least one of the user identification information, environment information, waste product category information, waste identification information and biological processing information.

2. The method as recited in claim 1, wherein obtaining user identification information includes obtaining a user specification of an access code.

3. The method as recited in claim 1, wherein obtaining user identification information includes determining user identification based on an input device.

4. The method as recited in claim 1, wherein the environment information includes at least one of time of day, temperature, and geographic position.

5. The method as recited in claim 1, wherein determining one or more waste product categories includes obtaining a user selection of one or more statically provisioned waste product categories.

6. The method as recited in claim 1, wherein determining one or more waste product categories includes processing at least a portion of the target waste product collection to determine at least one waste product category.

7. The method as recited in claim 6, wherein processing at least a portion of the target waste product collection includes performing a biological processing of the at least a portion of the waste product collection.

8. The method as recited in claim 1, wherein obtaining waste identification information includes obtaining multi-media information associated with the collected waste product.

9. The method as recited in claim 1, wherein obtaining waste identification information includes obtaining a weight of the collected waste product.

10. The method as recited in claim 9, wherein obtaining the weight of the collected waste product includes:
determining an initial weight of the waste processing unit prior to collection of waste product;
determining a subsequent weight of the waste processing unit upon collection of the waste product; and
associating a weight to the collected waste product based on processing the determined initial and subsequent weights.

11. The method as recited in claim 1, wherein processing information associated with the biological processing of waste product processing information includes performing a statistical analysis with regard to collected waste product information over time.

12. The method as recited in claim 1, wherein processing information associated with the biological processing of waste product processing information includes performing a statistical analysis with regard to collected waste product information for a plurality of waste processing units.

13. The method as recited in claim 1, wherein the waste product processing information includes a combination of the user identification information, environment information, waste product category information, waste identification information and biological processing information.

14. A method for managing waste product information associated with collection of waste products at a waste processing unit, the method comprising:
determining, by a waste processing unit, one or more waste product categories associated with a target waste product collection;
determining, by the waste processing unit, whether to enable waste product collections;
if waste product collected is determined to be enabled, causing, by the waste processing unit, collection of waste product;
obtaining, by the waste processing unit, waste identification information associated with the collected waste product;
causing, by the waste processing unit, biological processing of the collected waste product; and
processing information associated with the biological processing of waste product processing information.

15. The method as recited in claim 14 further comprising obtaining user identification information corresponding to a user specification of an access code.

16. The method as recited in claim 14 further comprising obtaining environment information corresponding to at least one of time of day, temperature, and geographic position.

17. The method as recited in claim 14, wherein determining one or more waste product categories includes obtaining a user selection of one or more statically provisioned waste product categories.

18. The method as recited in claim 14, wherein determining one or more waste product categories includes processing at least a portion of the target waste product collection to determine at least one waste product category.

19. The method as recited in claim 18, wherein processing at least a portion of the target waste product collection includes performing a chemical processing of the at least a portion of the waste product collection.

20. The method as recited in claim 14, wherein obtaining waste identification information includes obtaining multi-media information associated with the collected waste product.

21. The method as recited in claim 14 wherein obtaining waste identification information includes obtaining a weight of the collected waste product.

22. The method as recited in claim 14, wherein processing information associated with the biological processing of waste product processing information includes performing a statistical analysis with regard to collected waste product information over time.

23. The method as recited in claim 14, wherein processing information associated with the biological processing of waste product processing information includes performing a statistical analysis with regard to collected waste product information for a plurality of waste processing units.

24. The method as recited in claim 14, wherein the waste product processing information includes a combination of user identification information, environment information, waste product category information, waste identification information and biological processing information.

25. An apparatus for managing waste product information comprising:
a waste product processing subsystem for causing biological processing of collected waste product; and
a waste product management component including executable instructions, which when executed by hardware components associated with the apparatus cause the waste product management component to:
determine one or more waste product categories associated with a target waste product collection;
determine whether to enable waste product collections;
if waste product collected is determined to be enabled, cause collection of waste product;
obtain waste identification information associated with the collected waste product;
cause initiation of biological processing of the collected waste product by the waste product processing subsystem; and
process information associated with the biological processing of waste product processing information.

26. The apparatus as recited in claim 25, wherein the waste product management component is further operable to obtain user identification information.

27. The apparatus as recited in claim 25, wherein the waste product management component is further operable environment information.

28. The apparatus as recited in claim 25, wherein the waste product management component obtains a user selection of one or more statically provisioned waste product categories.

29. The apparatus as recited in claim 25, wherein the waste product management component processes at least a portion of the target waste product collection to determine at least one waste product category.

30. The apparatus as recited in claim 25, wherein the waste product management component processes at least a portion of the waste product collection.

31. The apparatus as recited in claim 25, wherein the waste product management component obtains multi-media information associated with the collected waste product.

32. The apparatus as recited in claim 25, wherein the waste product management component obtains a weight of the collected waste product.

33. The apparatus as recited in claim 25, wherein the waste product management component performs a statistical analysis with regard to collected waste product information over time.

34. The apparatus as recited in claim 25, wherein the waste product management component performs a statistical analysis with regard to collected waste product information for a plurality of waste processing units.

35. The method as recited in claim 14, wherein the waste product processing information includes a combination of user identification information, environment information, waste product category information, waste identification information and biological processing information.
